(19) United States
(12) Patent Application Publication
(10) Pub. No.: US 2003/0193841 A1
(43) Pub. Date: Oct. 16, 2003

(54) Flashing instrument indicator

(76) Inventor: Paul D. Crunk, Taylor, MI (US)

Correspondence Address: PAUL CRUNK, 12220 WOODCREST BOX 725, TAYLOR, MI, 48180, US

(21) Appl. No.: 10/122,820

(22) Filed: Apr. 14, 2002

(51) Int. Cl. G04B 47/00; G04B 19/30

(52) U.S. Cl. 368/67

(57) ABSTRACT

A lighted instrument indicator or flashing type indicator contained inside an instrument like an hourmeter, tachometer, voltage meter or any other type instrumentation allowing a visual indication displaying the instrument is ON and also can display the performance of the application that the instrument is attached thereto. The type of indicator can be a standard flashing light bulb, LED or EL-light under the face, through the face or flashing illuminated back light LCD dial contained within the instrument or be in a separate area on the face, side, back or any other area on instrument that can clearly inform to operator through visual indication that the instrument is operating or the performance of the application thereto which the meter is monitoring. This visual indicator will also help the operator to not forget to turn the ignition switch off on the equipment or machine in which the meter is monitoring. The present invention using the flashing indicator can also inform the operator by how the indicator is appearing during the time of use, which can change the indicator flash cycle from a steady light to gradually flashing quicker and quicker or changing the flash pattern from pattern to pattern or can use multiple illuminated segments that can light up different colors or can flash differently to informing the operator the condition of the equipment or machine the instrument is thereto attached and monitoring.

### BACKGROUND OF INVENTION

At the present time instruments do not have any sort of indicator showing that the instrument is functioning or know the performance of the application in which the meter it monitoring.

Most electrical-mechanical hourmeter's produce on the world market do not give the operator any sort of visual indication that the instrument is ON and is. Most people will have to look very closely at the instrument when it is in operation, which can take many minutes at a time to just to verify that the instrument is actually being powered and is properly functioning. Many customers in the marketplace mention that they have to put their ear onto instrument to verify the instrument is actually operating. In the marketplace today especially in the heavy-duty equipment industry, lawn and garden industry, rental industry, knowing the meter is operating when it is being used is very critical for the operator or the maintenance personnel to be able to monitor and service the equipment or machine the meter is thereto attached. A flashing instrument indicator can be used on pulse counters, electrical mechanical hourmeter's, digital hourmeter's, voltage meters or any other type instrument that the operator needs to know that the instrument is functioning properly. The flash rate from the indicator can be a steady ON, can flash or change to different flash patterns using one or more illuminated sources or the flashes rate can be changed into a sequential pattern of flashes to indicate the performance of gasoline or diesel engine or electric motor or equipment thereto being used at the time. The most important part of this flashing indicator is to give visual aid to the operator that the instrument is turned ON and is operating without the operator having to look very closely at the dial or put their ear next to the meter to confirm the meter is working, which is not physically possible for operator to do or is it safe when operator has to put his or her ear next to an instrument to be able to confirm that the instrument is operating. This visually lighted indicator can be of any color, or can change colors or brightness, and can be seen by the operator outside in direct sunlight or indoor from many viewing angles.

### BRIEF SUMMARY OF THE INVENTION

The present invention provide a visual illumination or indication to the operator that the instrument is functioning when the equipment or machine is operating without having to get up next to the instrument to visually see or hear that the instrument is functioning which can be a major safety problem to the operator. The present invention solves the issue of the operator not knowing if the instrument is ON or OFF, or not knowing the performance of application the instrument is monitoring. Now with a simple quick glance at the visual indicator/s the operator will immediately know in split-second that the instrument is ON and information of the application the meter is monitoring. The flashing indicator can be contained with in that single instrument or the indicator can be external using output points on the meter to attach a visual display on any panel that can display the operation that meter or many other instruments at the same time. With a simple glance the operator can now know that the instrument is or is not working. If the instrument is not working it can now give quick clear indication that the instrument is not working or the application that the instrument is their attached to it is also not on or not functioning correctly.

### BRIEF SUMMARY OF THE INVENTION

The present invention is about instrumentation having a flashing indicator contained with inside the instrument that can be a flashing LED giving clear visibility of the condition of the instrument or its operation. This flashing indicator can be of any color or shape using a light emitting diode or any other type of lighting source that can be molded into the case or front faceplate or placed underneath a clear lens protecting the LED from the environment outside the instrument. The instrument can be an hourmeter, tachometer, voltage meter or any other type instrument requiring additional visibility using a lighted indicator showing the performance of the equipment or machine and indicating to the operator the running condition thereto with it instrument is attached and informing to the operator that the instrument is ON and functioning

### BRIEF DESCRIPTION OF THE DRAWINGS

A more complete appreciation of the invention and the many advantages thereof will be readily obtained as the same becomes better understood by reference to the following detailed description when considered in connection with accompanying drawings, wherein:

FIG. 1 Showing a simple hourmeter assembly with slide-on retaining clip, locking slots in meter case, male connectors, a flat style front cover, a flush type clear instrument display window, a LED display window and printing on the meter cover.

FIG. 2 Showing a simple hourmeter with locking slots in meter case, male connectors lens, instrument display window, LED display window.

FIG. 3 Showing a simple hourmeter PCB with LED attached and the clear window to let the light out and see meter behind the display window.

FIG. 4 Showing a simple hourmeter PCB with the LED attached to it.

### DETAILED DESCRIPTION OF THE INVENTION

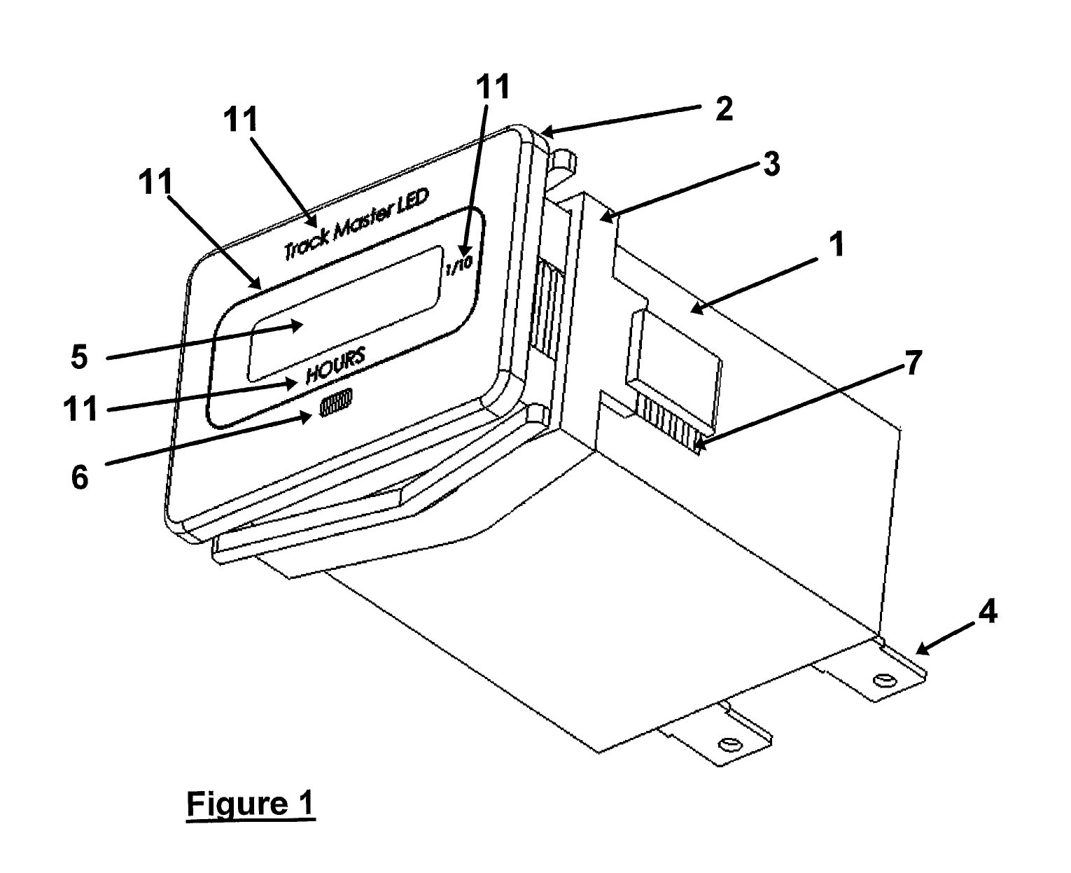

Turning now to FIG. 1 You will find a simple hourmeter 1 with a quick connect mounting retaining clip 3 that slides over the case 1 and fits into the case slots 7 on the case 1, which the retaining clip 3 slides up to secure the meter for a tight fit to the bottom area of the meter face plate 2 to hold the meter secure in place when mounted. This model simple meter uses two male flat type connectors 4 for easy hook up with a simple wire harness found on must applications of use in the world market. The meter cover 2 is ultrasonic welded to the case 1 where the cover 2 has printing 11 on it for the required information need, which can be see above and below the lens 5 and 6 on the front cover.

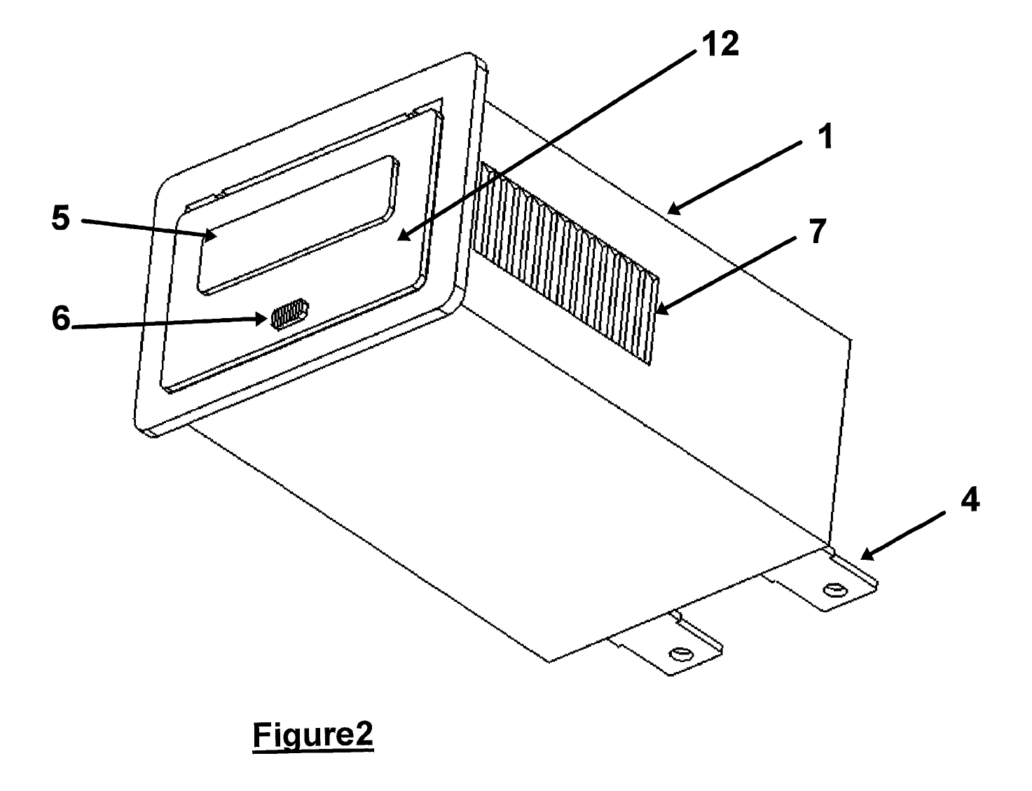

Now turning to FIG. 2 you can see the lens 12 fits perfectly into the case 1 which allows the raised areas 5 and 6 to stick through the front cover 2 in FIG. 1 to be easily seen from many viewing angles. You can also view the case slots 7 in the side of the meter case 1 for the retaining clip 3 with locking barbs (not seen) to lock into the case slots 7, which secures the meter to the bottom area of the meter face plate 2 and the two male connectors 4 for easy connections to standard female connectors used on many application in the world market.

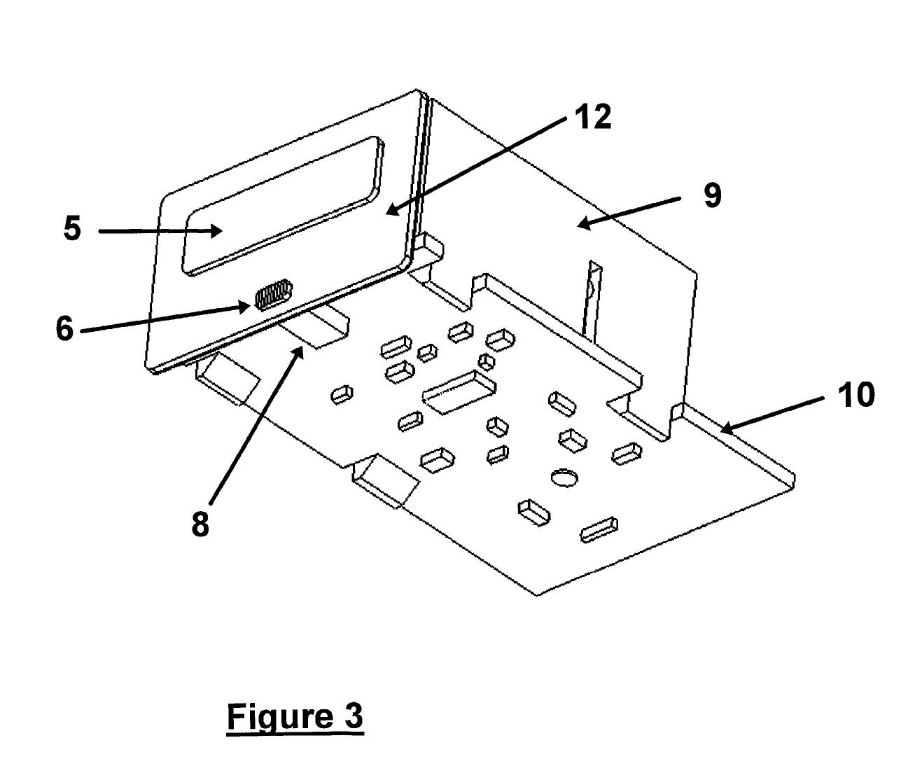

Now turning to FIG. 3 you can see the meter case 9 that hold the meter components inside, the lens 12 that has a raised display window 6 and LED window 6 where the LED 8 is attached to the PCB 10 that fits behind the LED window 6 allowing the light being produced by the LED 8 to project through the LED window 6 and to be seen in many viewing angles. Also you can see the meter clearly through the display window 5 and and LED through 6 that is flush with the surface of the meter face 2 allowing clear view of the digital or analogue meter and LED 8 contained inside the meter case 9, which PCB 10 and case 9 both slide into the meter case 1, which the front cover 2 is placed on case 1 to complete the meter assembly.

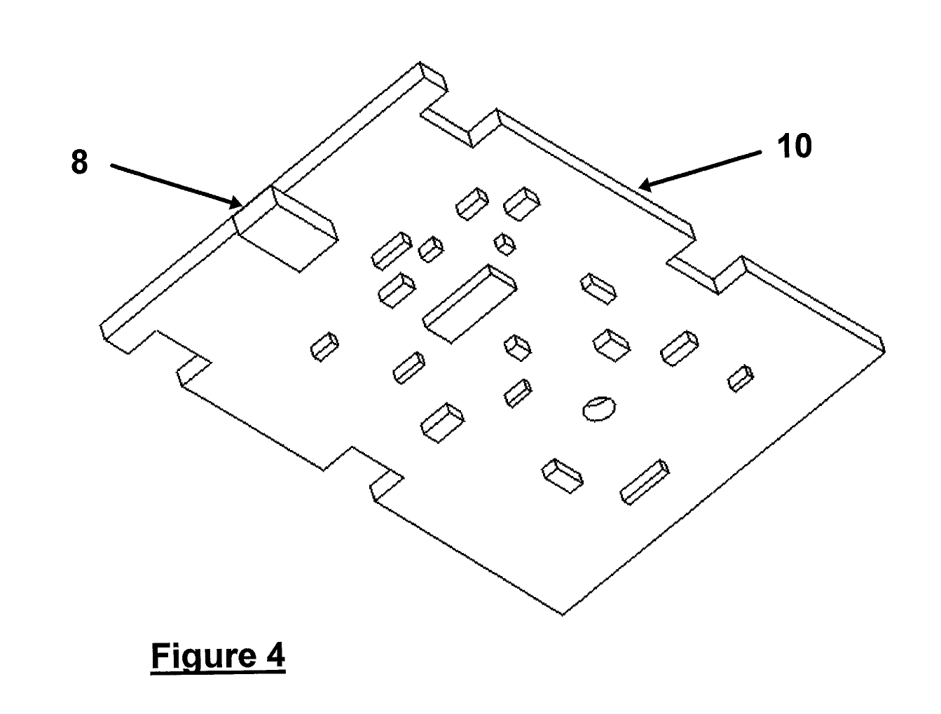

Now turning to FIG. 4 you can clearly see that the led 8 is attached to the meter PCB 10 that slides into the meter case 1 where the front cover attaches to the case 1 using ultrasonic welding to make the meter water tight.

What is claimed is:

1. An instrument lighted indicator contained within an instrument like a hourmeter, tachometer, voltage meter or any other type instrumentation displaying a steady ON or flashing visual light seen by a man or woman of indication that the instrument is turned ON and is operating.

2 An instrument lighted indicator contained within an instrument that can flash any cycle rate or any type pattern using any type lighting source, but preferably using LED's of any color shape, design, pattern or brightness that can remain one color or change colors.

3. An instrument lighted indicator contained within an instrument that also offers external connection points or additional lead wires to an exterior lighting source to offer extra indication and operation of the application the instrument is being used thereon.

4. Dependant on claim 1 and 2, an instrument indicator contained within an instrument that can change colors, the flash rate or display any type lighting pattern or colors using any type lighting source, but preferably using a single LED or multiple LED's to display visual information.

5. Dependant on claim 1 and 2 where an instrument indicator contained within an instrument, which the lighted source sticks through the instrument face plate or meter case of allowing better visibility of the lighted indicator.

6 Dependent on claims 1 and 2 where the lighted source inside the meter or external can include EL lighting, LED, incandescent, LED or light bulb back lighting or a combination one or more lighted sources to achieve some special visual effects.
